(19) United States
(12) Patent Application Publication
(10) Pub. No.: US 2026/0267362 A1
(43) Pub. Date: Sep. 10, 2026

(54) Automatic Liquid Dispenser

(71) Applicant: Vienna Wyler, Franklin, TN (US)

(72) Inventor: Vienna Wyler, Franklin, TN (US)

(21) Appl. No.: 19/070,756

(22) Filed: Mar. 5, 2025

(51) Int. Cl. G05D 9/12

(52) U.S. Cl. CPC G05D 9/12

(57) ABSTRACT

The disclosed technology is generally directed to a liquid dispensing system that utilizes real-time sensor data to dynamically control liquid flow into a container. The system includes a liquid dispensing spout with at least one valve, a sensor array configured to detect the presence, dimensions, and position of a container, and a liquid measurement sensor that monitors the fill status of the container in real time. A processor processes sensor data to dynamically adjust dispensing parameters, including liquid flow rate, based on detected fill speed and total liquid volume dispensed. The processor controls actuation of the valve to regulate liquid flow and prevent overfilling. By continuously adapting to real-time conditions, the system enhances accuracy, efficiency, and safety in automated liquid dispensing applications.

### TECHNICAL FIELD

This disclosure is directed to liquid dispensing systems, and more particularly, to liquid dispensing systems with automated fill detection and control.

### BACKGROUND

Automated liquid dispensing systems are commonly used in a variety of applications, including beverage dispensing, industrial fluid distribution, laboratory sample preparation, and pharmaceutical formulation. These systems are designed to deliver precise quantities of liquid into a container or receptacle, minimizing waste, improving efficiency, and reducing human error.

Conventional automated liquid dispensing systems typically employ simple flow control mechanisms such as mechanical valves, timed dispensing cycles, or pre-measured volumetric dispensing. Many existing systems rely on rudimentary sensors or fixed dispensing rates, which can result in inefficiencies when handling containers of varying sizes, shapes, or fill capacities. Additionally, some systems require manual calibration or rely on pre-programmed settings that do not adapt dynamically to real-time conditions, leading to potential inaccuracies in the fill process.

In certain commercial and industrial applications, liquid dispensing systems integrate basic sensors, such as weight-based load cells or infrared sensors, to detect the presence of a container and initiate dispensing. However, these systems often lack the ability to dynamically adjust flow rates based on real-time feedback regarding the liquid level within the container. As a result, they may be prone to overfilling, spills, or inconsistent fill levels.

Many current liquid dispensing systems require manual activation by a user, such as pressing a button or applying pressure to a switch. It would be desirable to provide improved liquid dispensing systems that are automated and eliminate the need for user interaction.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In an exemplary embodiment of the present disclosure, a liquid dispensing system is provided. The liquid dispensing system may include a liquid dispensing spout having at least one valve. The liquid dispensing system may also include a sensor array having a set of sensors. Each of the set of sensors is configured to detect presence of a container relative to the liquid dispensing spout, dimensions of the container and position of the container. Each of the set of sensors can generate first sensor data indicating the dimensions of the container and position of the container. The liquid dispensing system may also include at least one liquid measurement sensor configured to detect fill status of the container in real time. The liquid measurement sensor can generate second sensor data that indicates the fill status of the container. The liquid dispensing system may also include a processor that executes control logic for managing a dispensing process. The processor may process the first sensor data and the second sensor data and dynamically adjust dispensing parameters for filling of the container with liquid. The dispensing parameters may include: a liquid flow rate based on real-time fill speed and total liquid volume dispensed. The processor may calculate an ideal fill height based on detected dimensions of the container and dynamically adjust the dispensing parameters accordingly. In some implementations, the processor determines an optimal fill rate based on the dimensions of the container and dynamically adjusts the flow rate of the liquid into the container. The processor may control actuation of the least one valve based on the dispensing parameters to control the liquid flow rate to the container and prevent overflow of the container during the filling process. In some implementations, the liquid measurement sensor continuously monitors the liquid level until the container reaches a predetermined fill level, at which point the processor controls the valve to stop dispensing liquid. Implementations may include one or more of the following features.

In some implementations, the set of sensors may include at least one of: an ultrasonic sensor to measure container height and detect liquid levels in a container; an infrared sensor to validate positioning and alignment container with respect to the liquid dispensing spout; an optical sensor configured to detect a height, a diameter, and a volume of the container; a capacitive sensor to detect the presence of liquid without direct contact; a sound or vibrational sensor to detect the frequencies emitted from the container as the container fills with liquid; and a weight sensor to determine liquid volume changes.

In some implementations, the liquid dispensing system may include: a housing having a head, a base, and a body that couples the head to the base. The liquid dispensing spout may be disposed in the head, the base, or the body of the housing. In some implementations, the set of sensors are arranged at different heights along the body of the liquid dispensing system to detect the presence of the container and dimensions of the container.

Implementations may include one or more of the following features. In some implementations, the liquid measurement sensor may include: a camera-based sensor configured to capture images of the container and liquid level within the container and detect one or more features associated with a container. The camera-based sensor generates data that can be used to recognize a type of container, dimensions and volume capacity of the container, liquid fill level of the container as the container fills with liquid, and placement of the container relative to the liquid dispensing spout. The processor is configured to execute an artificial intelligence-based object recognition algorithm to determine one or more of: the type of container, the dimensions and volume capacity of the container, the liquid fill level within the container as the container fills with liquid, and placement of the container relative to the liquid dispensing spout.

In some implementations, the processor is configured to control actuation of the valve to dynamically adjust a liquid flow rate from the liquid dispensing spout based on container dimensions and the second sensor data that indicates the fill status of the container detected by the liquid measurement sensor in real time. The fill status of the container indicates the fill progress of the container. In some implementations, the processor is configured to execute an AI-driven pattern recognition algorithm that optimizes fill times by predicting optimal flow rates based on at least one of a shape of the container and a volume of the container.

In some implementations, the processor is further configured to determine whether the container is level and aligned with the liquid dispensing spout before initiating the filling process. In some implementations, the processor is configured to generate a command to actuate the at least one valve to close and halt dispensing of the liquid when one or more of the following conditions is detected: movement of the container, obstruction of the at least one valve, and an irregular fill pattern. In some implementations, the processor is configured to execute an adaptive safety module that detects unexpected movement of the container, obstructed flow from the liquid dispensing spout, or failure to reach expected fill levels, and halts liquid dispensing of the liquid in response to such detections.

In some implementations, the liquid dispensing system may further include: at least one additional liquid dispensing spout disposed in a base of the liquid dispensing system. The at least one additional liquid dispensing spout may be configured to dispense liquid into the container from a bottom opening of the container. For instance, in one implementation, the housing of the liquid dispensing system may include a plurality of liquid dispensing spouts disposed at different locations within the housing. This can enable dispensing of different liquid types or dispensing of liquid from multiple directions. The plurality of liquid dispensing spouts may be positioned for either overhead, side-mounted, or bottom-fed dispensing of liquid into the container.

In some implementations, the processor detects the uppermost sensor in the sensor array that has detected liquid and uses this detection to determine a liquid level within the container.

In some implementations, the liquid dispensing system may include at least one of: a heating element for heating the liquid prior to dispensing the liquid in response to a heating command from the processor, and a cooling element for cooling the liquid prior to dispensing the liquid in response to a cooling command from the processor.

In some implementations, the liquid dispensing system may include a user interface that allows for an input to place the liquid dispensing system in a manual override mode. The manual override mode allows for manual dispensing of liquid into the container to accommodate non-standard container shapes or sizes.

In some implementations, the liquid dispensing spout is adjustable in height to accommodate containers of varying sizes.

Implementations of the described system may include hardware, a method or process, or a computer tangible medium. The system may include one or more computers configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by at least one processor, cause the apparatus to perform the actions. Other embodiments of this aspect include corresponding computer systems, apparatus, and computer programs recorded on one or more computer storage devices, each configured to perform the actions of the methods.

Further aspects, features, applications, and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIGS. 1A-1D are perspective views of a liquid dispensing system in which aspects of the technology may be employed; and

FIG. 2 is a block diagram illustrating one example of a computing elements in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for liquid dispensing systems with automated fill detection and control. The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features.

Prior to describing exemplary embodiments that incorporate the features of the present disclosure, a discussion of technical problems with conventional liquid dispensing systems and technologies will now be provided. As described above, conventional liquid dispensing systems and technologies require manual activation, and while some can automatically detect the presence of a container and be pre-programmed to dispense predetermined amounts of liquid they suffer from various drawbacks that can prevent automatic refills of a container and/or dynamic adjustment of the refill level based on container size. For example, many conventional liquid dispensing systems require a user to determine the fullness of the container and remove it in time for it to be filled correctly. Conventional liquid dispensing systems also lack real-time feedback on liquid levels. Thus, it would be desirable to provide improved liquid dispensing systems that address these drawbacks among others.

Recent advancements in sensor technology and artificial intelligence have opened the possibility for more sophisticated automated liquid dispensing systems that can dynamically adapt to different container dimensions, optimize flow rates, and enhance safety. Despite these advancements, many existing systems still lack the ability to precisely detect container dimensions, monitor fill progress in real-time, and intelligently control dispensing parameters to prevent errors such as spillage or misalignment of the container with the dispensing spout. Accordingly, there is a need for an improved automated liquid dispensing system that leverages advanced sensing technologies, adaptive control mechanisms, and real-time feedback processing to enhance the accuracy, efficiency, and safety of the dispensing process.

In accordance with the disclosed embodiments, an adaptive, sensor-driven liquid dispensing system is provided. The liquid dispensing system detects container dimensions and container fullness, and dynamically adjusts flow rates to ensure precise fill levels without manual intervention or container-specific pre-programming. Using a combination of sensor technologies, including one or more of ultrasonic sensors, infrared sensors, optical sensors, capacitive sensors, vibration sensors, weight sensors, and AI-driven computer vision. The system can use sensor data from these sensors determine container characteristics, monitor fill status, and optimize dispensing efficiency. The automated liquid dispensing system utilizes the combination of sensors and AI-driven camera modules to detect container presence, dimensions, and liquid fill levels in real time. The system dynamically adjusts dispensing parameters to ensure precise and efficient filling without manual intervention. The dispensing system can eliminate user interaction during the filling process. Unlike existing solutions, this system can function with various container sizes, refill automatically based on detected liquid levels, and dispense from multiple source positions, including above, below, or from the side of the liquid dispensing system. In other words, the dispensing spouts can be positioned above, beside, or below the container, allowing for flexible installation in various environments. The system also includes adaptive safety mechanisms and optional temperature control, making it suitable for applications in homes, restaurants, gyms, and healthcare facilities.

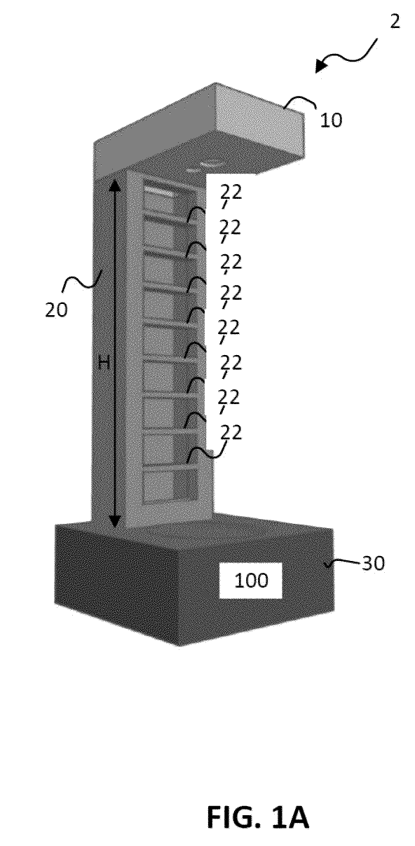

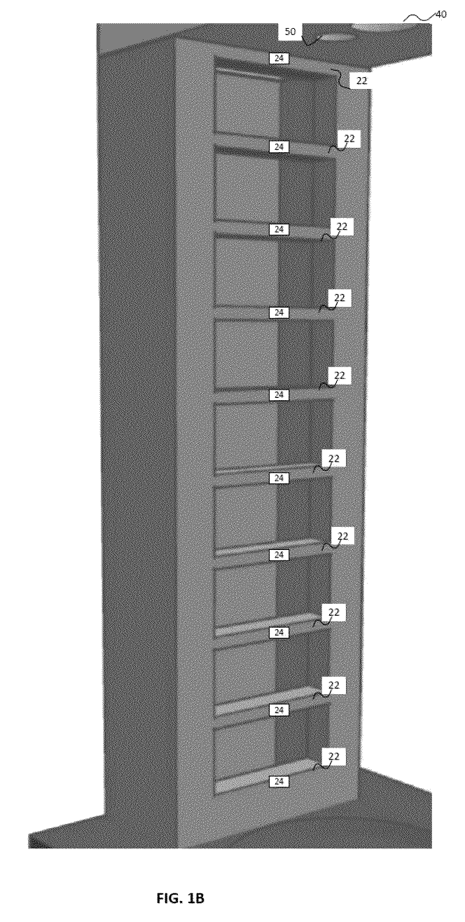

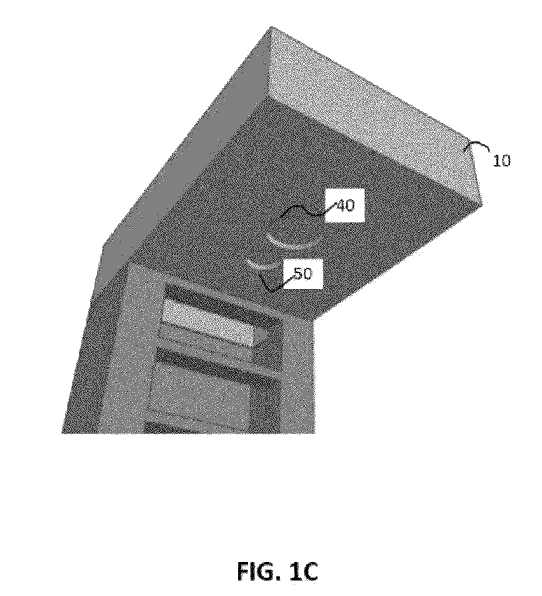

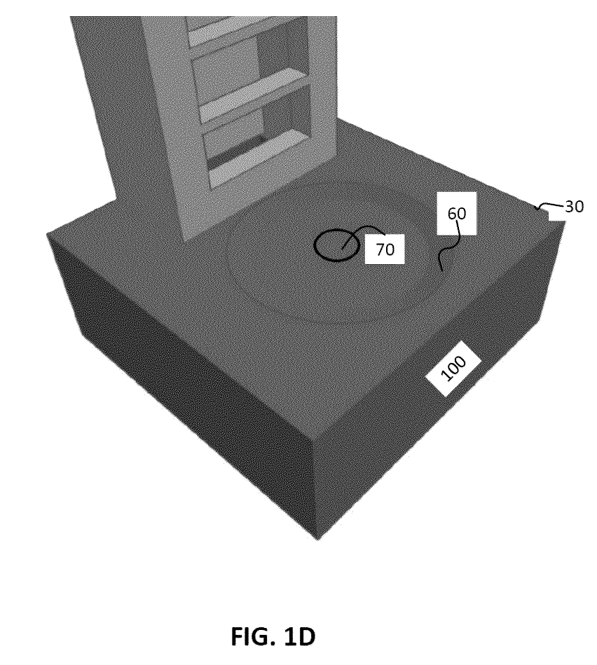

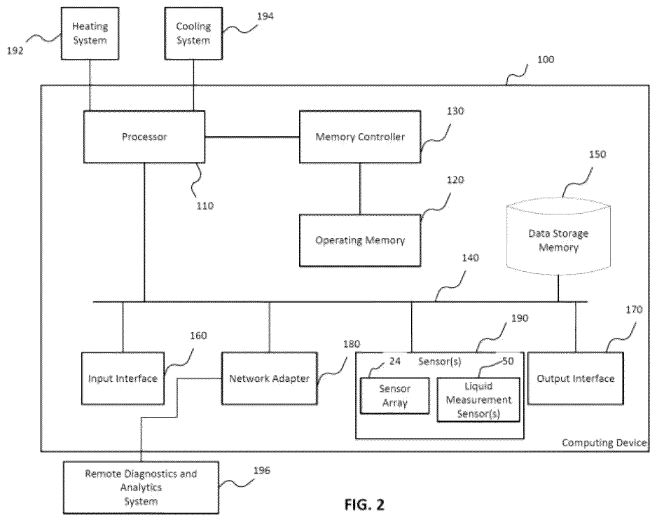

In one non-limiting embodiment, an automated liquid dispensing system is provided that utilizes real-time sensor data to dynamically control liquid flow into a container. The system includes a liquid dispensing spout with at least one valve, a sensor array configured to detect the presence, dimensions, and position of a container, and a liquid measurement sensor that monitors the fill status of the container in real time. A processor processes sensor data to dynamically adjust dispensing parameters, including liquid flow rate, based on detected fill speed and total liquid volume dispensed. The processor controls actuation of the valve to regulate liquid flow and prevent overfilling. By continuously adapting to real-time conditions, the system enhances accuracy, efficiency, and safety in automated liquid dispensing applications. Examples of liquid dispensing systems that can be applied within the context of the present disclosure will now be described with reference to FIGS. 1A-2.

FIGS. 1A-1D are perspective views of an automated liquid dispensing system 2 in which aspects of the technology may be employed. Specifically, FIG. 1A is a perspective view of the liquid dispensing system 2 in which aspects of the technology may be employed. As illustrated in FIG. 1A, in one non-limiting embodiment, the liquid dispensing system 2 includes a head 10, a body 20 and a base 30 that collectively form a housing of the liquid dispensing system 2. The housing of the liquid dispensing system 2 can be made from any material, such as metal, plastic or glass as a few non-limiting examples. The housing of the liquid dispensing system 2 can be manufactured using a variety of manufacturing technologies some of which include casting, 3D printing, and/or injection molding. The housing or enclosure of the liquid dispensing system 2 may house a computing device that includes various computing elements, including a processor or a processing circuitry, as will be described with reference to FIG. 2 below. The various computing elements of the computing device may be housed and distributed throughout the housing in any manner.

As shown in FIG. 1B, in one non-limiting embodiment, the body 20 of the automated liquid dispensing system 2 has a height (H) which can fit the desired container (not illustrated) to be filled. In the case of common drinking cups as one non-limiting example, the height (H) of the body 20 may be ten inches tall. The body 20 may include any number of structural members 22 that can each include or enclose one or more sensors 24 along a front face of the body 20 to measure the dimensions of the container including the height, volume and/or shape of a container when it is inserted in the automated liquid dispensing system 2. Collectively, the sensors 24 form an array of sensors that sense within a specific distance for the presence of a container. Depending on the implementation, the sensors 24 may include one or more of: ultrasonic sensors to measure container height and detect liquid levels in a container; infrared, light or optical sensors to validate positioning and alignment container with respect to at least one liquid dispensing spout 40, 70; capacitive sensors to detect the presence of liquid without direct contact; sound or vibrational sensors to detect the frequencies emitted from the container as it fills; and/or load cells or weight sensors to determine liquid volume changes.

The sensors 24 of the sensor array continuously monitor for the presence of a container within a predefined distance of the sensors 24. When a container is detected by the sensors 24, the sensors 24 may collectively detect or measure one or more dimensions of a container, and provide the detected dimensions to a processor, which can in turn process the outputs of the sensors 24. For example, outputs of the sensors 24 can be processed by a processor to determine one or more of the height, diameter, volume, and/or shape of the container. In some implementations, each of sensors 24 in the array of sensors can also detect liquid in the container, and provide this information to the processor, which can then use that information to compute the level of liquid in the container as it is filled with liquid during the filling process. For instance, the upper most one of the sensors 24 that detects the liquid can be used by the processor to determine the relative fill level or height of liquid in the container as it is filled during the filling process. Once the level of liquid in the container reaches a desired fill level or height, the processor can close a valve of the liquid dispensing spout 40, 70 and end the filling process. In one embodiment, the valve of the liquid dispensing spout can be an electronically controlled solenoid valve. In one embodiment, camera-based sensors that generate data that can be used to recognize container type, dimensions, and liquid fill levels in real-time.

FIG. 1C illustrates further details of the head 10 of the liquid dispensing system 2. As shown in FIG. 1C, in one non-limiting embodiment, the head 10 may include at least one liquid dispensing spout 40 and one or more liquid measurement sensors 50 that can be used to measure changes in the liquid level in real time. In some embodiments, the liquid measurement sensor 50 may include a camera module. The processor can use this information from the camera module and execute AI algorithms to recognize the container type, estimate volume capacity, and validate fill progress.

In one embodiment, the liquid dispensing spout 40 is positioned to align over an opening in a top of a container (not shown in FIG. 1C). The dispensing spout 40 includes a controllable valve that can be actuated by a processor to open or close the valve. By controlling the valve, liquid can be dispensed into an opening in the top of the container and fill the container with liquid.

As shown in FIG. 1C, the liquid measurement sensor 50 may be disposed in the head 10 so that it can measure the height of liquid in the container (not shown). In some embodiments, the liquid measurement sensor 50 can detect the location of the top of a container, the height of a container, the diameter of a container, the volume of a container and/or the shape of a container. In some embodiments, information detected by the liquid measurement sensor 50 can be processed by a processor to ensure that the container is level and that an opening of the container is placed under and aligned with the liquid dispensing spout 40. The liquid measurement sensor 50 may consistently measure the height of liquid as it is dispensed into the container through its built-in liquid dispensing spout 40. The processor may implement adaptive safety algorithms that can use sensor data from the liquid measurement sensor 50 and/or the sensors 24 to detect things such unexpected movement of the container, an obstructed flow from the valves of the liquid dispensing spouts 40, 70, or failure to reach expected fill levels. Upon detecting any of these events, the processor controls the valves of the liquid dispensing spouts 40, 70 to automatically halt dispensing of liquid. This can prevent spills, overfilling or other malfunctions.

FIG. 1D illustrates further details of the base 30 of the liquid dispensing system 2. As shown in FIG. 1D, in one non-limiting embodiment, the base 30 may include a depression 60 for the placement of a container (not shown), and another optional liquid dispensing spout 70 that includes a controllable valve that can be actuated to dispense liquid into an opening in a bottom of a container (not shown in FIG. 1D) and fill the container from the bottom of the container. As shown in FIGS. 1A and 1D, in one non-limiting embodiment, the computing device 100 may also be disposed in the base 30 of the liquid dispensing system 2.

When an object, such as a container, is detected by the sensors 24 as being inserted into the liquid dispensing system 2, the sensors 24 can output signals to a processor of the computing device 100. One of the signals from each sensor 24 indicates whether that particular sensor 24 has detected the presence of the container, while another signal from each sensor indicates the distance between the container and the sensors 24. The processor can calculate a height of the container by determining which ones of the sensors 24 have detected the container and which sensors 24 cannot detect the object. Once the height is known, the processor can communicate the height of the container to other elements including the liquid measurement sensor 50. In one embodiment, the processor can also compute the volume of the container based on the dimensions of the container. In another embodiment, the maximum potential volume of the container will be known and therefore processor can compute a fill rate to fill the container based on the potential volume.

The liquid measurement sensor 50 can continuously sense the distance between the sensor 50 and the liquid in the container and feed this sensor data back to the processor. The processor can continuously determine and monitor the height of the liquid within the container as the liquid is dispensed into the container, and control actuation of a valve of at least one of the liquid dispensing spouts 40, 70 to dynamically adjust and modulate the flow rate of liquid from at least one of the liquid dispensing spouts 40, 70. The processor can interpret sensor data from the sensor 50 and dynamically adjust actuation of a valve of at least one of the liquid dispensing spouts 40, 70 to control the liquid flow to achieve optimal fill speed while preventing overflows. For example, the processor can use the sensor data from the sensor 50 to determine an optimal fill rate and control actuation of a valve of at least one of the liquid dispensing spouts 40, 70 to dispense liquid from an opening of the dispensing spout. In some cases, the processor can control the flow of liquid from at least one of the liquid dispensing spouts 40, 70 so that the liquid flows at an appropriate rate and so that the desired amount of liquid is dispended to fill the container. The processor can control and modulate the flow of liquid from at least one of the liquid dispensing spouts 40, 70 based on the detected fill rate to ensure rapid yet controlled filling of the container. When the distance between the sensor 50 and the liquid reaches a predetermined distance such that the liquid dispensed has a desired height within the container (e.g., to fill the container), the processor can communicate a control signal to close the valve and stop dispending liquid into the container.

In one embodiment, the processor and the liquid measurement sensor 50 can use information regarding the height of each individual sensor 24 in relation to the height of the spout 40 and then calculate the height that the liquid should reach in the filling process. For example, the processor can use information regarding the height of each individual sensor 24 and their respective distances from the liquid measurement sensor 50 or the spout 40 to calculate an ideal height that the liquid should reach to fill the container. For instance, the height of the uppermost one of the sensors 24 that has detected the container and the dimensions of the container (e.g., height, diameter, shape and/or volume of the container) can be used to calculate an amount of liquid to be dispensed to fill the container. In one embodiment, the liquid measurement sensor 50 can continuously monitor the fill level of the liquid until the container is filled, at which point the processor will close the valve of the spout 40 to stop dispensing the liquid. In one embodiment, the processor can vary the flow rate as a function of fill speed and total liquid volume dispensed in order to achieve the shortest fill time.

In the example illustrated in FIGS. 1A-1D, the liquid dispensing spouts 40, 70 are disposed in the head 10 and the base 30 of the housing of the liquid dispensing system 2. However, in other implementations, the liquid dispensing spouts 40, 70 can be disposed in other locations of the housing such as the body 20 or other areas of the head 10 and the base 30 of the housing. For example, the liquid dispensing spouts 40, 70 may be positioned at various positions above, beside, or below the container, allowing for flexible integration into different environments like homes, restaurants, gyms, hospitals, and other environments. As such, the system may support dispensing of liquid into a container from various positions, including overhead, side-mounted, or bottom-fed configurations. In addition, although not illustrated, in some implementations, the housing may include fewer or more than two liquid dispensing spouts to allow for multi-source dispensing of different liquids.

FIG. 2 is a diagram illustrating one example of a computing device 100 in which aspects of the technology may be practiced. Computing device 100 may be virtually any type of general-purpose or specific-purpose computing device. For example, computing device 100 may be an example of a controller or a processor of the liquid dispensing system 2 as described above with reference to FIGS. 1A-1D.

As illustrated in FIG. 2, computing device 100 includes a processor or processing circuit 110, operating memory 120, memory controller 130, data storage memory 150, input interface 160, output interface 170, one or more network adapter(s) 180, and in some embodiments, one or more sensor(s) 190. Each of these afore-listed components of computing device 100 includes at least one hardware element.

Computing device 100 include at least one processor 110 configured to execute instructions, such as instructions for implementing the herein-described workloads, processes, or technology. Processor 110 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 120 during run-time of computing device 100. Operating memory 120 may also include any of a variety of data storage devices/components, such as volatile memories, semi-volatile memories, random access memories, static memories, caches, buffers, or other media used to store run-time information. In one example, operating memory 120 does not retain information when computing device 100 are powered off. Rather, computing device 100 may be configured to transfer instructions from a non-volatile data storage component (e.g., data storage memory 50) to operating memory 120 as part of a booting or other loading process. In some examples, other forms of execution may be employed, such as execution directly from data storage memory 150.

Operating memory 120 may include 4th generation double data rate (DDR4) memory, 3rd generation double data rate (DDR3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processor 110 via memory controller 130 in channels. One example of computing device 100 may include one or two DIMMs per channel, with one or two ranks per channel. Operating memory within a rank may operate with a shared clock, and shared address and command bus. Also, an operating memory device may be organized into several banks where a bank may be thought of as an array addressed by row and column. Based on such an organization of operating memory, physical addresses within the operating memory may be referred to by a tuple of channel, rank, bank, row, and column.

Despite the above discussion, operating memory 120 specifically does not include or encompass communications media, any communications medium, or any signals per se.

Memory controller 130 is configured to interface processor 110 to operating memory 120. For example, memory controller 130 may be configured to interface commands, addresses, and data between operating memory 120 and processor 110. Memory controller 130 may also be configured to abstract or otherwise manage certain aspects of memory management from or for processing circuit 10. Although memory controller 130 is illustrated as single memory controller separate from processor 110, in other examples, multiple memory controllers may be employed, memory controller(s) may be integrated with operating memory 120, or the like. Further, memory controller(s) may be integrated into processor 110. These and other variations are possible.

In computing device 100, data storage memory 150, input interface 160, output interface 170, network adapters 1200, and sensors 190 may be interfaced to processor 110 by bus 140. Although, FIG. 2 illustrates bus 140 as a single passive bus, other configurations, such as a collection of buses, a collection of point-to-point links, an input/output controller, a bridge, other interface circuitry, or any collection thereof may also be suitably employed for interfacing data storage memory 150, input interface 160, output interface 170, or network adapters 1200 to processor 110.

In computing device 100, data storage memory 150 is employed for long-term non-volatile data storage. Data storage memory 150 may include any of a variety of non-volatile data storage devices/components, such as non-volatile memories, disks, disk drives, hard drives, solid-state drives, or any other media that can be used for the non-volatile storage of information. However, data storage memory 150 specifically does not include or encompass communications media, any communications medium, or any signals per se. In contrast to operating memory 120, data storage memory 150 is employed by computing device 100 for non-volatile long-term data storage, instead of for run-time data storage.

Also, computing device 100 may include or be coupled to any type of processor-readable media such as processor-readable storage media (e.g., operating memory 120 and data storage memory 150) and communication media (e.g., communication signals and radio waves). While the term processor-readable storage media includes operating memory 120 and data storage memory 150, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 100 also includes input interface 160, which may be configured to enable computing device 100 to receive input from users or from other devices, such as sensors 190, in some embodiments. In addition, computing device 100 includes output interface 170, which may be configured to provide output from computing device 100.

In the illustrated example, computing device 100 is configured to communicate with other computing devices or entities via network adapters 100. Network adapters 100 may include a wired network adapter, e.g., an Ethernet adapter, a Token Ring adapter, or a Digital Subscriber Line (DSL) adapter. Network adapters 100 may also include a wireless network adapter, for example, a Wi-Fi adapter, a Bluetooth adapter, a ZigBee adapter, a Long-Term Evolution (LTE) adapter, SigFox, LoRa, Powerline, or a G adapter.

Although computing device 100 are illustrated with certain components configured in a particular arrangement, these components and arrangement are merely one example of a computing device in which the technology may be employed. In other examples, data storage memory 150, input interface 160, output interface 170, or network adapters 1200 may be directly coupled to processor 110, or be coupled to processor 110 via an input/output controller, a bridge, or other interface circuitry. Other variations of the technology are possible.

Some examples of computing device 100 include at least one memory (e.g., operating memory 120) adapted to store run-time data and at least one processor (e.g., processor 110) that is adapted to execute processor-executable code that, in response to execution, enables computing device 100 to perform actions, where the actions may include, in some examples, actions for one or more methodologies or processes described herein.

In some embodiments, when the device or system include one or more sensors 190, the sensors may be configured to sense or gather data pertaining to the surrounding environment or operation of the device or system. Some examples of exemplary sensors capable of being electronically coupled with the device or system of the present disclosure (either directly connected to the device or system of the present disclosure or remotely connected thereto) may include but are not limited to: ultrasonic sensors to measure container height and detect liquid levels in a container; infrared, light or optical sensors to validate positioning and alignment container with respect to at least one liquid dispensing spout 40, 70; capacitive sensors to detect the presence of liquid without direct contact; sound or vibrational sensors to detect the frequencies emitted from the container as it fills; load cells or weight sensors to determine liquid volume changes, and/or camera-based sensors that generate data that can be used to recognize container type, dimensions, and liquid fill levels in real-time; pressure sensors for sensing pressure or pressure changes; sensors for measuring the amount of fluid passing thereby; audio sensors; photo/light sensors sensing light intensity; and temperature sensors sensing temperatures.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be to configure the devices or systems individually. Instead, an individual may provide configuration information, including baseline operational parameters, for several devices or systems at once.

In some embodiments, the liquid dispensing system 2 may optionally include a heating system 192 with heating elements to heat the liquid prior to it being dispensed, and/or a cooling system 194 with cooling elements to cool the liquid prior to it being dispensed. The processor can control the heating elements of heating system 192 to heat the liquid to a controlled temperature prior to it being dispensed. Likewise, the processor can control the cooling elements of cooling system 194 to cool the liquid to a controlled temperature prior to it being dispensed. In one implementation, the heating system 192 and the cooling system 194 of the liquid dispensing system 2 may be separate units. In another implementation, the heating system 192 and the cooling system 194 of the liquid dispensing system 2 may be a single unit that is controlled by the processor 110 in accordance with a selection method that depends on a user input from the input interface 160 that indicates whether the liquid is to be heated or cooled prior to being dispensed.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A liquid dispensing system, comprising:
a liquid dispensing spout comprising at least one valve;
a sensor array comprising a set of sensors configured to detect presence of a container relative to the liquid dispensing spout, dimensions of the container and position of the container, and generate first sensor data indicating the container dimensions and the container position;
a liquid measurement sensor configured to detect fill status of the container in real time and generate second sensor data that indicates the fill stratus of the container; and
a processor that executes control logic for managing a dispensing process, the processor being configured to:
process the first sensor data and the second sensor data and dynamically adjust dispensing parameters for filling of the container with liquid, wherein the dispensing parameters comprise: a liquid flow rate based on real-time fill speed and total liquid volume dispensed; and
control actuation of the least one valve based on the dispensing parameters to control the liquid flow rate to the container and prevent overflow of the container during the filling process.

2. The liquid dispensing system of claim 1, wherein the set of sensors comprises at least one of:
an ultrasonic sensor to measure container height and detect liquid levels in a container;
an infrared sensor to validate positioning and alignment container with respect to the liquid dispensing spout;
an optical sensor configured to detect a height, a diameter, and a volume of the container;
a capacitive sensor to detect the presence of liquid without direct contact;
a sound or vibrational sensor to detect the frequencies emitted from the container as the container fills with liquid; and
a weight sensor to determine liquid volume changes.

3. The liquid dispensing system of claim 1, wherein the liquid measurement sensor comprises:
a camera-based sensor configured to capture images of the container and liquid level within the container and detect one or more features associated with a container,
wherein the camera-based sensor generates data that can be used to recognize a type of container, dimensions and volume capacity of the container, liquid fill level of the container as the container fills with liquid, and placement of the container relative to the liquid dispensing spout, and
wherein the processor is configured to execute an artificial intelligence-based object recognition algorithm to determine one or more of:
the type of container,
the dimensions and volume capacity of the container,
the liquid fill level within the container as the container fills with liquid, and
placement of the container relative to the liquid dispensing spout.

4. The liquid dispensing system of claim 1, wherein the processor is configured to control actuation of the valve to dynamically adjust a liquid flow rate from the liquid dispensing spout based on container dimensions and the second sensor data that indicates the fill status of the container detected by the liquid measurement sensor in real time, wherein the fill status of the container indicates the fill progress of the container.

5. The liquid dispensing system of claim 1, wherein the liquid dispensing system comprises:
a housing comprising a head, a base, and a body that couples the head to the base, wherein the liquid dispensing spout is disposed in the head, the base, or the body of the housing.

6. The liquid dispensing system of claim 1, wherein the liquid dispensing system comprises at least one of:
a heating element for heating the liquid prior to dispensing the liquid in response to a heating command from the processor; and
a cooling element for cooling the liquid prior to dispensing the liquid in response to a cooling command from the processor.

7. The liquid dispensing system of claim 1, wherein the processor is configured to generate a command to actuate the at least one valve to a dynamically regulate or halt dispensing of the liquid in response to detecting one or more of the following conditions: movement of the container, obstruction of the at least one valve, irregular fill pattern, or sensor-detected deviation from expected liquid flow rates.

8. The liquid dispensing system of claim 1, wherein the processor is configured to execute an AI-driven pattern recognition algorithm that is trained on historical fill data and sensor feedback to optimize fill times by predicting optimal flow rates based on at least one of a shape of the container and a volume of the container.

9. The liquid dispensing system of claim 1, wherein the liquid dispensing system further comprises:
a user interface that allows for an input to place the liquid dispensing system in a manual override mode that allows for manual dispensing of liquid into the container to accommodate non-standard container shapes or sizes.

10. The liquid dispensing system of claim 1, wherein the set of sensors are arranged at different heights along a body of the liquid dispensing system to detect the presence of the container and dimensions of the container.

11. The liquid dispensing system of claim 1, wherein the processor is further configured to determine whether the container is level and aligned with the liquid dispensing spout before initiating the filling process.

12. The liquid dispensing system of claim 1, wherein the processor is configured to execute an adaptive safety module that detects unexpected movement of the container, obstructed flow from the liquid dispensing spout, or failure to reach expected fill levels, and halts liquid dispensing of the liquid in response to such detections.

13. The liquid dispensing system of claim 1, wherein the system further comprises:
at least one additional liquid dispensing spout disposed in a base of the liquid dispensing system, the at least one additional liquid dispensing spout being configured to dispense liquid into the container from a bottom opening of the container.

14. The liquid dispensing system of claim 1, further comprising:
a housing; and
a plurality of liquid dispensing spouts disposed at different locations within the housing to enable dispensing of different liquid types or dispensing from multiple directions,
wherein the plurality of liquid dispensing spouts are positioned for either overhead, side-mounted, or bottom-fed dispensing of liquid into the container.

15. The liquid dispensing system of claim 1, wherein the processor determines an optimal fill rate based on the dimensions of the container and dynamically adjusts the flow rate of the liquid into the container.

16. The liquid dispensing system of claim 1, wherein the processor detects the uppermost sensor in the sensor array that has detected liquid and uses this detection to determine a liquid level within the container.

17. The liquid dispensing system of claim 1, wherein the liquid measurement sensor continuously monitors the liquid level until the container reaches a predetermined fill level, at which point the processor controls the valve to stop dispensing liquid.

18. The liquid dispensing system of claim 1, wherein the processor calculates an ideal fill height based on detected dimensions of the container and dynamically adjusts the dispensing parameters accordingly.

19. The liquid dispensing system of claim 1, wherein the liquid dispensing spout is adjustable in height to accommodate containers of varying sizes.
